(19) United States
(12) Patent Application Publication
(10) Pub. No.: US 2013/0239184 A1
(43) Pub. Date: Sep. 12, 2013

(54) Method and System for Controlling a Safe from a Remote Computing Device

(71) Applicant: BURROUGHS, INC., Plymouth, MI (US)

(72) Inventors: Edward McHugh, Lake Zurich, IL (US); Robert A. Walters, Northville, MI (US); Joseph M. Gagnier, Birmingham, MI (US)

(73) Assignee: Burroughs, Inc., Plymouth, MI (US)

(21) Appl. No.: 13/791,260

(22) Filed: Mar. 8, 2013

Related U.S. Application Data
(60) Provisional application No. 61/609,035, filed on Mar. 9, 2012.

(51) Int. Cl. H04L 29/06

(52) U.S. Cl. CPC H04L 63/08
USPC 726/4

(57) ABSTRACT

Systems and methods for controlling a safe are disclosed. The system includes a safe having one or more networked devices, a mobile computing device, and a virtual safe controller server (VCF). The VCF server is configured to initiate a control session of the safe, determine a role of the user, transmit an instruction to the mobile computing device indicating one or more graphical user interfaces to display based on the role of the user, receive a command from the mobile computing device via the network, and transmit the command to the networked device over the network. The control session provides a user of the mobile computing device control of the networked devices. The role of the user is indicative of actions that the user has permission to perform on the networked devices. The command indicates a commanded action to be performed on a networked device.

### CROSS REFERENCE TO RELATED APPLICATIONS

This U.S. patent application claims priority under 35 U.S.C. §119(e) to U.S. Provisional Application 61/609,035, filed on Mar. 9, 2012. The disclosures of these prior applications are considered part of the disclosure of this application and are hereby incorporated by reference in their entireties.

### TECHNICAL FIELD

This disclosure relates to a method and system for controlling a safe from a remote computing device.

### BACKGROUND

Many brick-and-mortar retail stores and other cash businesses utilize safes to keep relatively large amounts of cash on-hand. Typically, cash is deposited into the safe and the safe owner (or an agent thereof) maintains the dollar amount that has been deposited in the safe. In some scenarios, the cash is placed in a drop bag, or similar apparatus. Periodically, an armored car service, or an equivalent thereof, empties the cash from the safe and delivers the cash to a bank. For example, a driver of an armored car may exchange an empty drop bag for the drop bag in the safe. The driver then delivers the drop bag to the bank. The bank verifies the amount of cash delivered by the armored car service and credits the amount to an account of the safe owner.

As the safes have evolved, so too have the control systems on the safes. Currently, each safe may require its own user interface, e.g., keypad, screen, and/or touchpad, and control system. The control systems may include one or more microcontrollers that are programmed for the specific functions of the safe. These gains in technology have increased the cost of safes, thereby pricing many retail store owners out of the market for such safes.

### SUMMARY

One aspect of the disclosure provides a method for controlling a safe is disclosed. The method includes initiating, at a processing device of a server, a control session of a safe, the control session providing a user of a computing device control of one or more networked devices associated with the safe. The method further includes determining, at the processing device, a role of the user, the role being indicative of one or more actions that the user has permission to perform on a set of networked devices of the one or more networked devices. The method also includes transmitting, at the processing device, an instruction to the computing device indicating one or more graphical user interfaces to display at the computing device based on the role of the user. The method also includes receiving, at the processing device, a command from the computing device over a network indicating a commanded action to be performed on a networked device of the one or more networked devices. The method further includes transmitting, at the processing device, the command to the networked device over the network.

Another aspect of the disclosure provides a server. The server includes a communication device configured to communicate over a network and a processing device that executes a controller module. The controller module is configured to initiate a control session of a safe, the control session providing a user of a computing device control of one or more networked devices associated with the safe. The controller module is further configured to determine a role of the user, the role being indicative of one or more actions that the user has permission to perform on a set of networked devices of the one or more networked devices. The controller module is additionally configured to transmit an instruction to the computing device indicating one or more graphical user interfaces to display at the computing device based on the role of the user. The controller module is configured to receive a command from the computing device via the network, the command indicating a commanded action to be performed on a networked device of the one or more networked devices. The controller module is also configured to transmit the command to the networked device over the network.

Another aspect of the disclosure provides a system. The system includes a safe having one or more networked devices associated therewith, the networked devices each being connected to a network and performing a function related to the safe, the safe being without a user interface. The system further includes a mobile computing device having a user interface configured to receive input from and display output. The system also includes a virtual safe controller server. The virtual safe controller server is configured to initiate a control session of the safe, the control session providing a user of the mobile computing device control of the one or more networked devices associated with the safe. The virtual safe controller server is also configured to determine a role of the user, the role being indicative of one or more actions that the user has permission to perform on a set of networked devices of the one or more networked devices. The virtual safe controller server is further configured to transmit an instruction to the mobile computing device indicating one or more graphical user interfaces to display at the mobile computing device based on the role of the user. The virtual safe controller server is additionally configured to receive a command from the mobile computing device via the network, the command indicating a commanded action to be performed on a networked device of the one or more networked devices. The virtual safe controller server is also configured to transmit the command to the networked device over the network.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A and 1B are drawings of a system for controlling a safe from a remote computing device over a network.

FIG. 2 is a drawing of an example of a computing device, a virtual safe controller server, and a safe in operable communication.

FIG. 3 is a drawing of an example graphical user interface for controlling a networked bill acceptor of a safe.

FIG. 4 is a drawing of an example graphical user interface for controlling a networked lock of a safe.

FIG. 5 is a schematic illustrating an example mobile computing device configured to control a safe.

FIG. 6 is a flow chart illustrating an example set of operations for a method for controlling a safe from a computing device.

FIG. 7 is a schematic illustrating an example server configured to control a safe based on commands received from a computing device.

FIG. 8 is a flow chart illustrating an example set of operations for a method for controlling a safe from a server based on commands received from a computing device.

FIG. 9 is a drawing of an example networked device configured to execute a redundancy controller.

FIG. 10 is a drawing of an example computing device and a safe in operable communication.

Like reference symbols in the various drawings indicate like elements.

### DETAILED DESCRIPTION

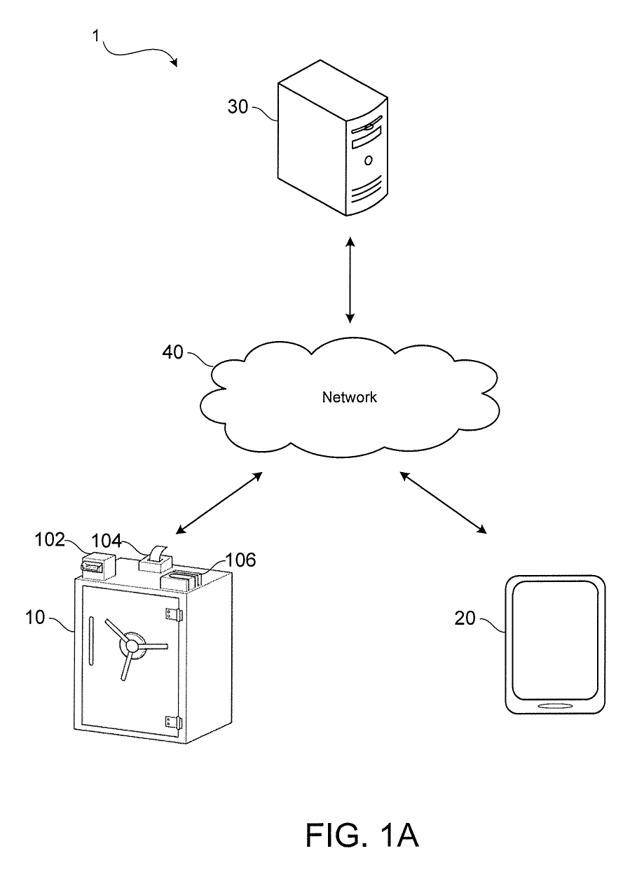

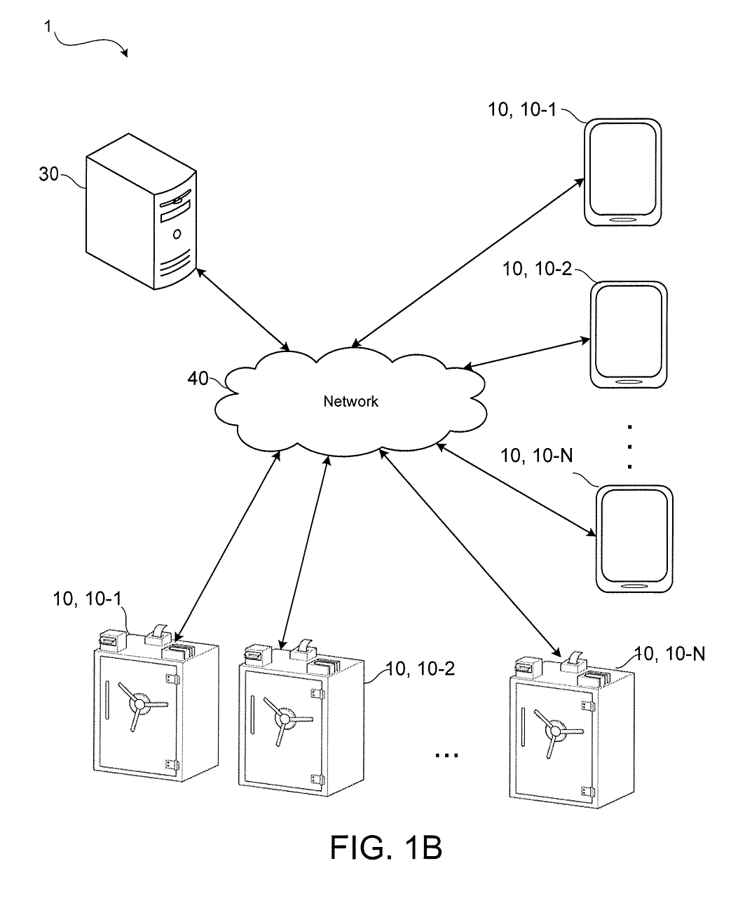

FIG. 1A illustrates a system 1 for controlling a safe 10 from a remote mobile computing device 20 over a network 40. The mobile computing device 20 is configured to control the safe via a virtual safe controller server 30 (a “VSC server”). According to some implementations of the present disclosure, the safe 10 does not have a user interface, e.g., a device configured to receive input from a user, and has one or more peripheral devices integrated therein. In some implementations, the peripheral devices are networked devices, such that each device is configured to communicate over the network 40. In the illustrated example, the safe 10 includes a networked bill acceptor 102, a networked printer 104, and a networked check scanner 106. The networked devices are provided for illustrative purposes only and not intended to be limiting. Each networked device may have a communication device, e.g., an antenna or communication port, for communicating over the network 40 and a microcontroller for executing commands received via the network 40. The networked devices receive commands to perform specific actions from the mobile computing device 20 via the VSC server 30. In response to receiving a command, the microcontroller of the recipient networked device performs the commanded action. For example, a user of the mobile computing device 20 may provide a command to the safe 10 to accept cash. The command may be sent to the VSC server 30, which in turn, transmits the command to the networked bill acceptor 102. In response to the command, a microcontroller of the networked bill acceptor 102 may turn the cash receptacle on, such that the bill acceptor 102 is able to receive cash deposits.

The mobile computing device 20 can be, for example, a tablet computer, a smartphone, or a laptop computer. Furthermore, while a mobile computing device 20 is discussed, the techniques described herein may be applied to stationary computing devices as well, e.g., personal computers. Thus, while reference is made to mobile computing devices 20, the teachings contained herein are equally applicable to stationary computing devices. The mobile computing device 20 is configured to act as the user interface for the safe 10. In this way, a user of the mobile computing device 20 can control one or more safes 10 using the same device.

The VSC server 30 is the control node of the system 1. As used herein, the term “server” can refer to one or more physical devices. In implementations where the VSC server 30 is comprised of more than one physical device, the devices can operate in a distributed or individual manner. The VSC server 30 is configured to receive commands from one or more mobile computing devices 20 and to transmit commands to one or more safes 10. For example, in FIG. 1B, the VSC server 30 controls safes 10-1, 10-2 . . . 10-N, where N is an integer greater than or equal to 1 based on commands received from mobile computing devices 20-1, 20-2, . . . 20-N. In the implementation of FIG. 1B, the user of one of the mobile computing devices 20 or the mobile computing device 20 selects a particular safe 10 to control. In some implementations, the mobile computing device 20 is configured to select a safe 10 from a plurality of safes based on the location of mobile computing device 20 and the locations of the safes 10. For example, the mobile computing device 20 may select the safe that is most proximate to the mobile computing device 20. Additionally or alternatively, the mobile computing device 20 may be configured to allow a user to choose or designate a safe 10 from the plurality of safes. In some implementations, the mobile computing device 20 may be configured to select the safe 10 by identifying a safe 10 in its personal area network. For example, the mobile computing device 20 and a component of the safe 10 may both include Bluetooth or near-field communication (NFC) transceivers, such that when the mobile computing device 20 is within a transmission range of the safe 10, the mobile computing device 20 selects the safe 10.

In response to a safe selection, the VSC server 30 can provide the mobile computing device 20 an instruction to display a graphical user interface (GUI) to perform one or more actions on the safe 10. The VSC server 30 may require authentication of the user and verification that the user has permission to access the selected safe prior to granting the user permission to control the safe. The VSC server 30 manages access to each safe 10 by only allowing permitted users to access a particular safe 10. Further, within the set of permitted users, the VSC server 30 may be configured to differentiate between the permitted users based on their defined role. For example, the types of users that may be permitted access to a safe 10 in a retail store setting can include a store clerk, a store manager, and an armored car driver. The foregoing list of users is provided for example only.

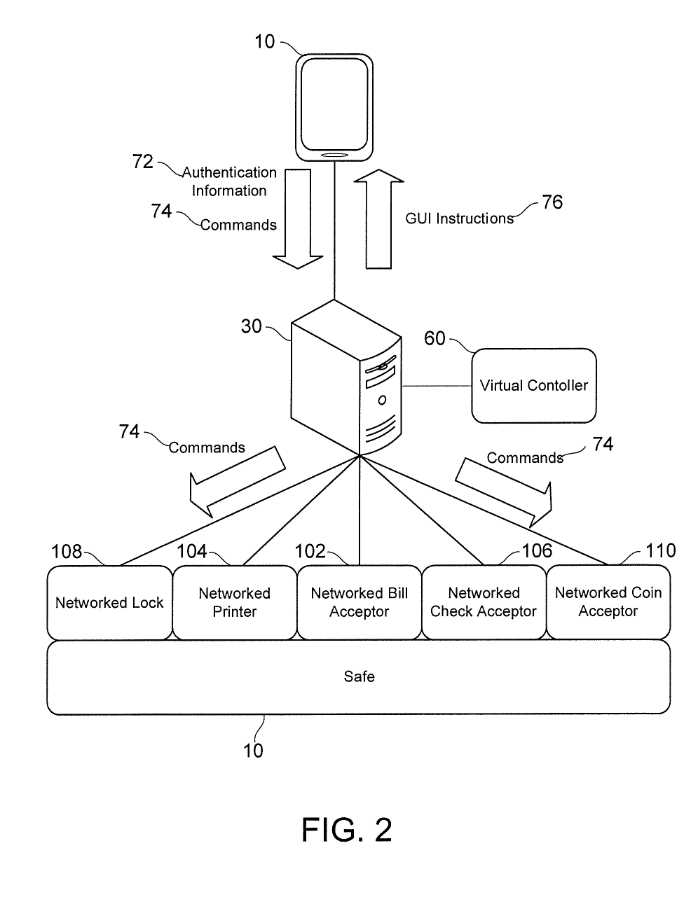

The VSC server 30 receives a request to initiate a control session for a particular safe 10 from the mobile computing device 20 and initiates a control session for the particular safe. In some implementations, the VSC server 30 instantiates a virtual safe controller for the particular safe 10. FIG. 2 illustrates an example of the VSC server 30 configured to provide a user control access to a safe 10 using a virtual safe controller 60. In the illustrated example, a mobile computing device 20 is requesting control access of the safe 10 from the VSC server 30. The request can include authentication information, e.g., username and password, of a user of the mobile computing device 20 and a selection of a safe 10 to which control access is requested. In response to the request, the VSC server 30 authenticates the user and instantiates a virtual safe controller 60 corresponding to the requested safe 10. An instantiated virtual safe controller 60 is configured to control the networked peripheral devices of the corresponding safe 10. In the illustrated example, the virtual safe controller 60 can control the networked bill acceptor 102, the networked printer 104, the networked check acceptor 106, the networked lock 108, and the networked coin acceptor 110.

In some implementations, communications between the mobile computing device 20, the VSC server 30, and the networked devices of the safe 10 are encrypted to secure the communications. In these implementations, the virtual safe controller 60 can be configured to receive encrypted commands from the mobile computing device 20. The virtual safe controller 60 may be further configured to decrypt the command, and then to encrypt the command for transmission to one of the networked devices. In these implementations, the networked devices are configured to decrypt the command prior to executing the command.

In some implementations, the virtual safe controller 60 determines a role of the user. The virtual safe controller 60 can determine which of the networked devices the user has permission to access and which actions can be performed on the permitted networked devices by the user based on the role of the user. The virtual safe controller 60 can provide a GUI instruction 76 to the mobile computing device 20 to display one or more GUIs corresponding to the permitted actions of the user. For instance, if the role of a first user is that of a store clerk, the first user may only be permitted to make deposits in the safe 10. Thus, when the first user, via a mobile computing device 20, requests a control session for the safe 10, the VSC server 30 instantiates a virtual safe controller 60 for the safe 10 and determines the role of the first user, i.e., store clerk. In this example, the role of store clerk only allows the first user to use the bill acceptor 102. Thus, the virtual safe controller 60 transmits a GUI instruction 76 to the mobile computing device 20 to display a GUI that allows the first user to control the bill acceptor 102.

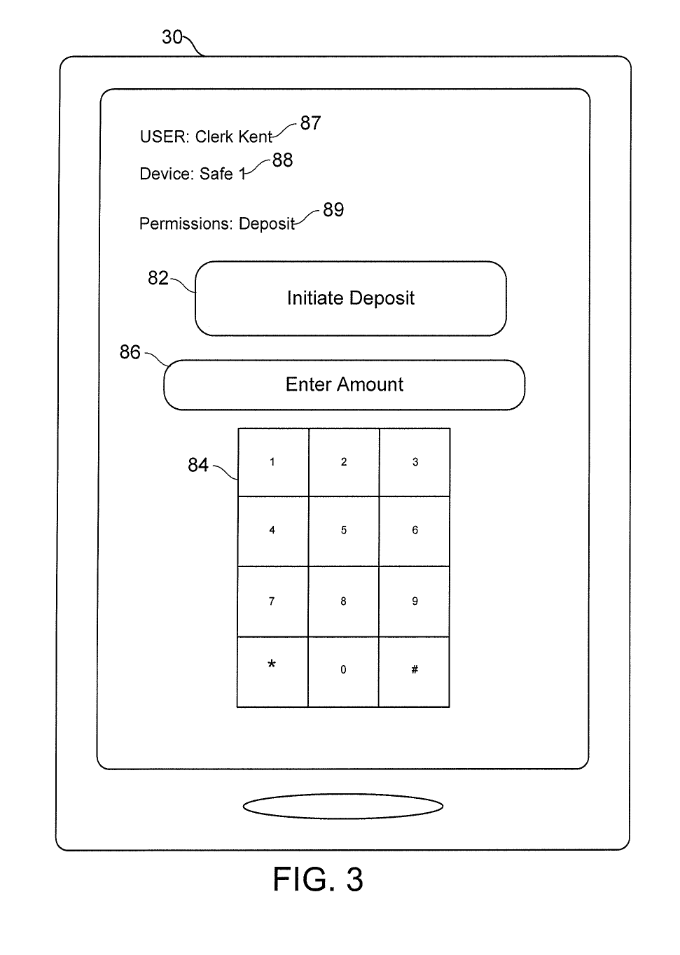

FIG. 3 illustrates an example deposit GUI 80 that may be displayed by the mobile device 20 in response to a GUI instruction 76 from the virtual safe controller 60. The GUI 80 may include a first input object 82 that allows the user to initiate a deposit and a second input object 84 that displays a keypad. The user can enter a dollar amount that is to be deposited in the cash dispenser using the second input object 84. The deposit GUI 80 may also include an output object 86 that displays the amount that the user entered using the second input object 84. The GUI 80 may further include a first field 87 that displays the name of the user, a second field 88 that displays an identifier of the safe 10 being controlled, and a third field 89 that displays the permissions of the user. The GUI 80 of FIG. 3 is provided for example only and is not intended to be limiting. Any suitable GUI may be implemented at the mobile computing device 20.

Using the GUI 80, the first user can deposit cash into the safe 10. The user can press the first input object 82 to activate the networked bill acceptor 102. In response to pressing the first input object 82, the mobile computing device 20 transmits a command 74 to the VSC server 30 indicating that the first user intends to deposit cash into the safe 10. The VSC server 30 routes the command 74 to the virtual safe controller 60, which forwards the command 74 to the networked bill acceptor 102. In response to receiving the command 74, the networked bill acceptor 102 can enter an active mode, such that the networked bill acceptor 102 is turned on and is able to accept bills. Once the first user has finished depositing cash into the bill acceptor 102, the bill acceptor 102 can transmit a notification indicating an amount of cash that was deposited. The first user can further enter the dollar amount using the second input object 84. The entered amount can be transmitted to the virtual safe controller 60 by way of the VSC server 30. The virtual safe controller 60 can verify that the amounts match and/or can update a deposit record corresponding to the safe 10.

In another example, a role of a second user may be that of an armored car driver who is responsible for picking up deposits made in the safe 10. In this example, the second user may only be permitted to unlock and lock the safe 10. Thus, when the second user, via a mobile computing device 20, requests a control session for safe 10, the VSC server 30 instantiates a virtual safe controller 60 for the safe 10 and determines the role of the second user, i.e., armored car driver. In this example, the role of armored car driver only allows the second user to use the networked lock 108. Thus, the virtual safe controller 60 transmits a GUI instruction 76 to the mobile computing device 20 to display a GUI that allows the first user to control the networked lock 108.

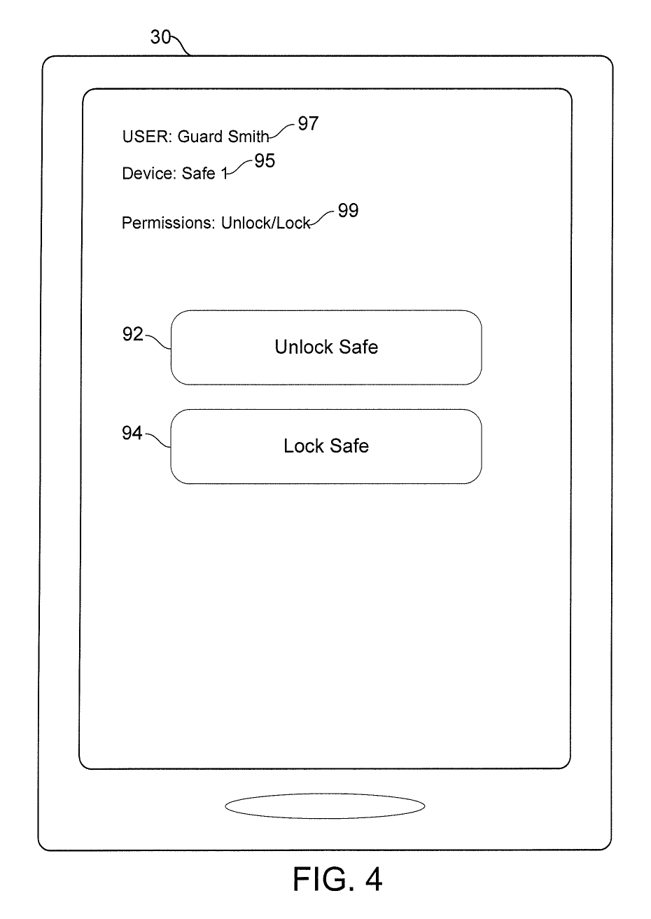

FIG. 4 illustrates an example lock/unlock GUI 90 that may be displayed by the mobile computing device 20 in response to a GUI instruction 76 from the virtual safe controller 60. The lock/unlock GUI 90 may include a first input object 92 that commands the networked lock 108 to unlock the safe 10 and a second input object 94 that commands the networked lock 108 to lock the safe 10. The GUI 80 may further include a first field 97 that displays the name of the user, a second field 98 that displays an identifier of the safe 10 being controlled, and a third field 99 that displays the permissions of the user. The GUI 90 of FIG. 4 is provided for example only and is not intended to be limiting. Any suitable GUI may be implemented at the mobile computing device 20.

Using the GUI 90, the second user can lock and unlock the safe 10 from the mobile computing device 20. The user can press the first input object 92 to unlock the safe 10. In response to pressing the first input object 92, the mobile computing device 20 transmits a command 74 to the VSC server 30 indicating that the safe is to be unlocked. The VSC server 30 routes the command 74 to the virtual safe controller 60, which forwards the command 74 to the networked lock 108. In response to receiving the command 74, the networked lock 108 unlocks the safe 10. When the second user has removed the cash from the safe 10, the second user can press the second input object 94. In response to pressing the second input object 94, the mobile computing device 20 transmits a command 74 to the VSC server 30 indicating that the safe is to be locked. The VSC server 30 routes the command 74 to the virtual safe controller 60, which forwards the command 74 to the networked lock 108. In response to receiving the command 74, the networked lock 108 locks the safe 10.

The foregoing examples of the first and second user are provided for illustrative purposes only and are not intended to be limiting. Similar techniques can be applied to activate the networked printer 104, the networked check acceptor 106, and the networked coin acceptor 110. Furthermore, any other suitable networked devices may have corresponding GUIs designed therefor.

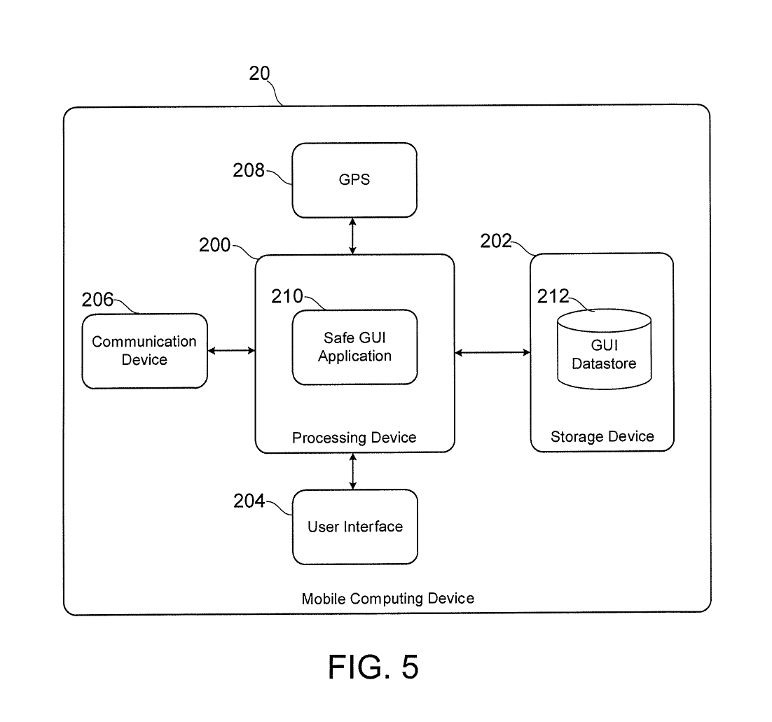

FIG. 5 illustrates an example mobile computing device 20 configured to control a safe 10. The components of the mobile computing device 20 can include, but are not limited to, a processing device 200, a storage device 202, a user interface 204, a communication device 206, and a global positioning system 208 (“GPS”). Additional or alternative components may be included in the mobile computing device 20 without departing from the scope of the disclosure.

The processing device 200 includes one or more processors and computer-readable memory (e.g., random access memory and/or read only memory) storing computer-readable instructions that are executed by the one or more processors. In implementations where the processing device 200 includes two or more processors, the processors can execute in a distributed or individual manner. The processing device 200 executes the safe GUI application 210.

The storage device 202 can include one or more storage mediums. Examples of storage mediums can include, but are not limited to, hard disk drives, optical disk drives, and flash memory. In the illustrated example, the storage device 202 stores the GUI datastore 212. The GUI datastore 212 stores various GUIs for performing various functions. The GUI datastore 212 can be periodically updated to include improvements to pre-existing GUIs or to add newly developed GUIs.

The user interface 204 includes one or more devices that allow a user to interface with the mobile computing device 20, i.e., receive output from and provide input to the mobile computing device 20. Examples of devices that can be included in the user interface 204 include a touchscreen, a touchpad, a display device, a keyboard, a mouse, a microphone, and a speaker.

The communication device 206 includes one or more suitable devices configured to send and receive data via the network 40. The communication device 206 can perform wireless or wired communication using any known or later developed communication standards. In some implementations, the communication device 206 can include one or more antennas configured to perform wireless communication using the IEEE 802.11 wireless protocol and/or one or more antennas configured to perform wireless communication according to any of the mobile telecommunication technology standards, e.g., 2G, 3G, or 4G. The communication device 206 enables the mobile computing device 20 to communicate with the VSC server 30, i.e., receive data from and route data to the VSC server 30 via the network 40.

The GPS 208 can include one or more receivers that receive signals from GPS satellites. The GPS 208 analyzes the received signals to determine location information. The location information may include the geographic coordinates (referred to as “GPS coordinates”) of the mobile computing device 20.

The safe GUI application 210 provides an interface between a user and the safe 10. The safe GUI application 210 can be embodied as computer-readable instructions that are executed by the processing device 200.

In operation, the safe GUI application 210 receives user input from a user via the user interface 204. Initially the safe GUI application 210 may receive authentication information from a user. The authentication information may include a username and a password of the user. The safe GUI application 210 provides the authentication information to the VSC server 30, which can authenticate the user. If the user can access more than one safe 10, the safe GUI application 210 can provide a safe selection to the VSC server 30. In some implementations, the safe GUI application 210 can obtain the GPS coordinates of the mobile computing device 20 from the GPS 208. Based thereon, the safe GUI application 210 or the VSC server 30 can select the closest safe 10 to the mobile computing device 20. Alternatively or additionally, the safe GUI application 210 can allow the user to select a specific safe 10 from the set of safes 10 to which the user has access. Once a safe 10 has been selected, the safe GUI application 210 can request a control session from the VSC server 30.

In response to providing a request to the VSC server 30, the safe GUI application 210 may receive an instruction to display one or more GUIs via the user interface 204. If the role of the user only allows a user to perform a single action, e.g., deposit, or set of functions, e.g., lock/unlock, then the safe GUI application 210 may display a GUI corresponding to the permitted action or set of actions. If the role of the user allows the user to perform multiple actions or sets of actions, then the safe GUI application 210 may provide the user the option to select which actions or set of functions that the user intends on performing. For example, if the user has a role of “manager,” the user may be allowed to deposit cash in the safe 10, to lock/unlock the safe 10, and to deposit checks into the safe 10. In such a scenario, the safe GUI application 210 may prompt the user to select a particular action or set of actions. Upon receiving a user selection, the safe GUI application 210 retrieves the corresponding GUI from the GUI datastore 212 and displays the GUI via the user interface.

While the GUI is displayed, the user can initiate commands via the GUI. Once the GUI receives input from a user via the user interface 204, the safe GUI application 210 generates a command corresponding to the received input and transmits the command to the VSC server 30. The user can continue to initiate commands until the user wishes to end the control session.

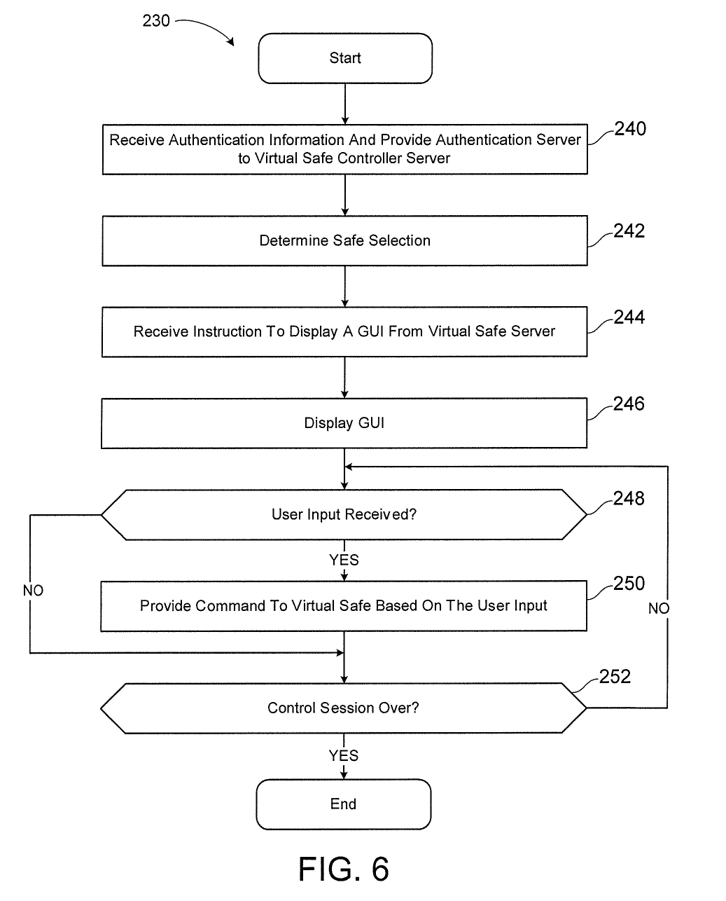

FIG. 6 illustrates an example set of operations for performing a method 230 for controlling a safe 10 from a computing device 20. For purposes of explanation, the method 230 is explained as being performed by the mobile computing device 20 of FIG. 5. The method 230 may be executed, however, by any suitable computing device.

The method 230 may begin executing when the safe GUI application 210 is launched by the user. At operation 240, the safe GUI application 210 receives authentication information of the user and provides the authentication information to the VSC server 30. If the user is successfully authenticated, the mobile computing device 20 receives verification of the same. If the user has permission to control more than one safe, the safe GUI application 210 determines a safe selection, as shown at operation 242. In some implementations, the safe GUI application 210 displays a list of the safes which the user can control and the user can provide an explicit selection. In other implementations, the safe GUI application 210 obtains the current location, e.g., GPS coordinates, of the mobile computing device 20. Either the safe GUI application 210 or the VSC server 30 can select a safe 10 based on current location of the mobile computing device 20. For instance, the safe 10 which is closest to the mobile computing device 20 may be selected.

At operation 244, the safe GUI application 210 receives an instruction to display one or more GUIs from the VSC server 30. As will be discussed below, the VSC server 30 determines which GUIs are to be displayed based on the role of the user. The instruction may include identifiers of the one or more GUIs. If more than one GUI is specified in the instruction, the safe GUI application 210 may prompt the user to select which action is to be performed. The safe GUI application 210 can retrieve the selected GUI from the GUI datastore 212. At operation 246, the safe GUI application 210 displays the GUI via the user interface 204.

At operation 248, the safe GUI application 210 determines whether the user has provided input to the displayed GUI. If so, the safe GUI application 210 provides a command corresponding to the user input to the VSC server 30, as shown at operation 250. At operation 252, the safe GUI application 210 determines whether the control session has ended. The control session may be explicitly ended by the user or may end due to being timed out as a result of inactivity for greater than a predetermined amount of time, e.g., ten minutes. If the control session has ended, the method 230 stops executing. Otherwise, the safe GUI application 210 continues to receive user input.

The method 230 is provided for example and not intended to be limiting. Variations of the method 230 are contemplated and are within the scope of the disclosure.

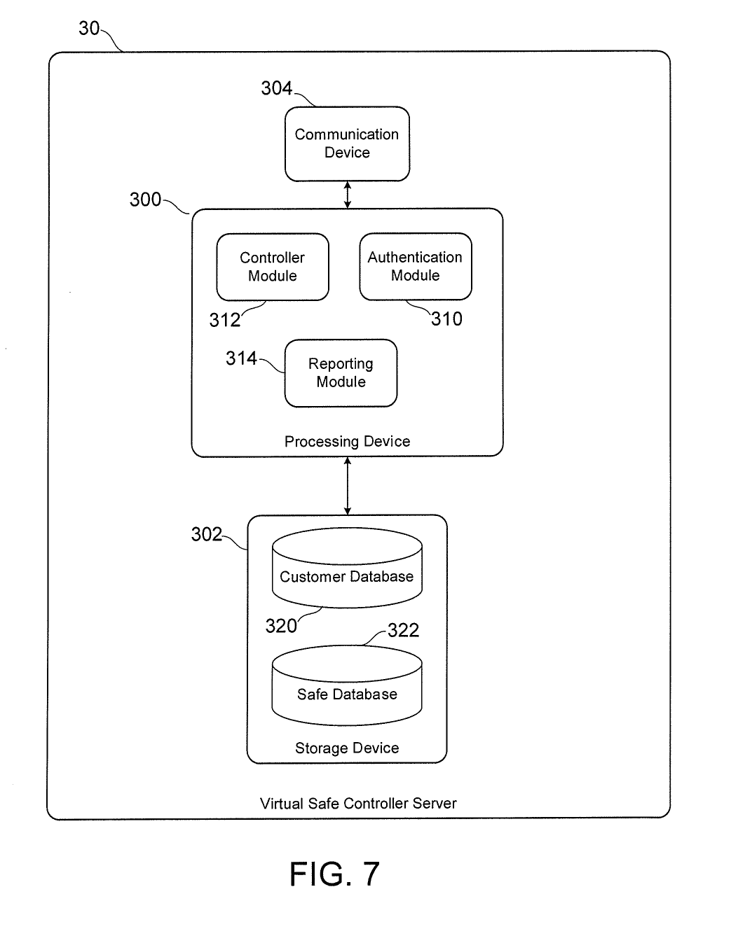

FIG. 7 illustrates a VSC server 30 configured to control a safe 10. The components of the VSC server 30 can include, but are not limited to, a processing device 300, a storage device 302, and a communication device 304. The list of components is provided for example only and not intended to be limiting. Additional or alternative components may be included in the VSC server 30 without departing from the scope of the disclosure.

The processing device 300 includes one or more processors and computer-readable memory (e.g., random access memory and/or read only memory) storing computer-readable instructions that are executed by the one or more processors. In implementations where the processing device 300 includes two or more processors, the processors can execute in a distributed or individual manner. The processing device 300 executes an authentication module 310, a controller module 312, and a reporting module 314.

The storage device 302 can include one or more storage mediums. Examples of storage mediums can include, but are not limited to, hard disk drives, optical disk drives, magnetic disk drives, and flash memory. In the illustrated example, the storage device 302 stores a customer database 320 and a safe database 322.

The customer database 320 stores customer entries which include information relating to a customer. As used herein, the term “customer” may refer to any entity which owns, leases, or otherwise controls a safe 10 that is controlled via the VSC server 30. For each customer associated with the VSC server 30, the customer database 320 may store a customer entry for the customer. Each customer entry may include a list of one or more safes 10 that the customer owns, leases, or otherwise controls. Further, each customer entry can include a list of one or more users associated with the customer and the safe 10 or safes 10 that each user has permission to access. The customer entry can also include the authentication information of each user or a file pathway to obtain the authentication information of each user. Further, for each user, the customer entry may define a role of the user with respect to each safe which the user is permitted to access. For example, a customer, C, may own two safes, S1 and S2, at two separate retail locations, L1 and L2, and may have one clerk working at each location, E1 at L1 and E2 at L2, and a manager M overseeing both retail locations. The entry corresponding to customer C may define that employee S1 works at location L1 and employee S2 works at location L2. Further, the entry may define that employee E1 has a clerk role for safe S1, employee E2 has a clerk role for safe S2, and employee M has a manager role for safes S1 and S2. Moreover, each entry may further define what actions are permitted for each defined role. For example, the clerk role may only allow a user to make cash deposits in the safe 10, while a manager role may allow a user to lock and unlock the safe, make cash deposits, make check deposits, and order reports regarding the safe. An entry in the customer database 320 may include additional information as well.

The safe database 322 can store safe entries corresponding to safes 10 which the VSC server 30 is configured to control. In some implementations, each safe entry is associated with a specific safe 10. The safe entry may include a location of the safe, GPS coordinates of the safe 10, the networked devices that are included in the safe 10, the IP address of each of the networked devices, the customer that owns, leases, or controls the safe 10, users that have access to the safe 10, and each users respective role with respect to the safe 10. In some implementations, the safe datastore 322 also stores safe controller objects for each safe 10, or paths thereto. A safe controller object (or objects) corresponding to a particular safe 10 can be instantiated to create a virtual safe controller 60 for the particular safe 10. The safe controller object can define interfaces for communicating with the networked devices of the particular safe 10, which may include the commands for controlling the networked devices. The safe database 322 may also store the current state of the safe 10. The current state of the safe 10 can include a list of deposits and withdrawals that have been made into the safe 10 over a given time period.

In some implementations, the safe database 322 and the customer database 320 can be combined into the same database. Furthermore, the contents of the safe database 322 and the customer database 320 are provided for example only and not intended to limit the scope of the disclosure.

The communication device 304 includes one or more suitable devices configured to send and receive data via the network 40. The communication device 304 can perform wireless or wired communication using any known or later developed communication standards. In some implementations, the communication device 304 can include one or more ports that physically connect the VSC server 30 to the network 40. The communication device 206 enables the VSC server 30 to communicate with mobile computing devices 20 and the safes 10.

The authentication module 310 authenticates a user of the mobile computing device 20. The authentication module 310 receives the authentication information of the user and cross-references the authentication information with the authentication information in the customer database 320. If the authentication information of the user matches authentication information in the customer database 320, the authentication module 310 can allow the user to request a control session. The authentication module 310 may be further configured to determine the safes 10 which the user has access to control and the role of the user with respect to each of the safes 10. The authentication module 310 may obtain this information from the customer database 320.

The controller module 312 initiates and maintains control sessions for one or more safes 10. In some implementations, the controller module 312 initiates a control session for a safe 10 by instantiating a virtual safe controller 60 corresponding to the safe 10. Once instantiated, the virtual safe controller 60 transmits an instruction to the mobile computing device 20 instructing the mobile computing device 20 to display one or more GUIs. The virtual safe controller 60 determines which GUIs to display based on the role of the user and the networked devices of the safe 10. The virtual safe controller 60 further receives command from the mobile computing device 20 which requested the control session. In response to receiving a command to perform a specific action, the virtual safe controller 60 generates a data packet containing the command and transmits the data packet to the IP address of the networked device implicated by the specific action. The virtual safe controller 60 can continue to receive commands from the mobile computing device 20 until the control session ends. Once a control session has ended, the controller module 312 can deactivate the virtual safe controller 60.

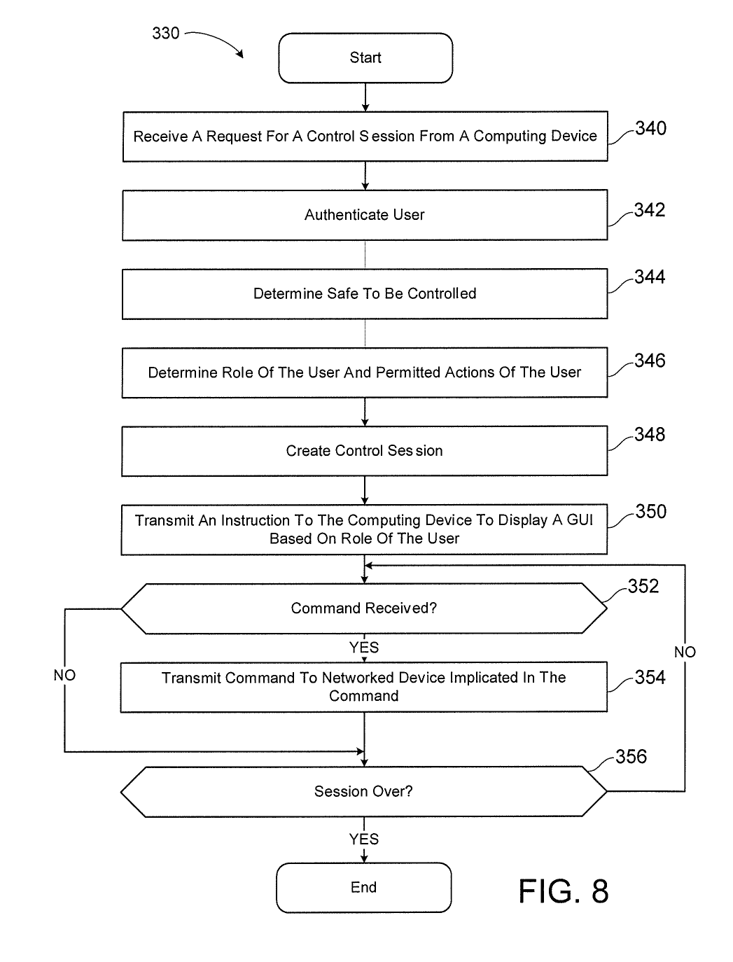

FIG. 8 illustrates an example set of operations for performing a method 330 for controlling a safe 10 by a server based on commands received from a remote computing device. For purposes of explanation, the method 330 is explained with reference to the VSC server 30 and a mobile computing device 20.

At operation 340, the VSC server 30 receives a request for a control session from a mobile computing device 20. The request for the control session may include authentication information of a user of the mobile computing device 20. At operation 342, the authentication module 310 can authenticate the user based on the authentication information. For example, the authentication module 310 can verify a username and password of the user based on the customer entries stored in the customer database 320.

At operation 344, the controller module 312 determines a safe 10 to be controlled during the control session. In some implementations, the safe 10 to be controlled is defined in the request for the control session. In some implementations, the request for the control session includes the location (e.g., GPS coordinates) of the mobile computing device 20. In these implementations, the controller module 312 can query the safe database 322 to determine one or more safes 10 in the proximity of the mobile computing device 20. Once determined, the controller module 312 can instruct the mobile computing device 20 to solicit a safe selection from the user or can automatically select the safe 10 closest to the mobile computing device 20.

At operation 346, the controller module 312 or the authentication module 310 determines the role of the user with respect to the selected safe 10. The controller module 312 can determine the role of the user from the customer database 320 or the safe database 322.

At operation 348, the controller module 312 creates a control session. In some implementations, the controller module 312 instantiates a virtual safe controller 60 that is configured to control the selected safe 10. The controller module 312 can retrieve a safe controller object corresponding to the selected safe. The safe controller object can define interfaces for communicating with the networked devices of the selected safe 10.

At operation 350, the controller module 312 transmits an instruction to the mobile computing device 20 to display one more GUIs based on the role of the user. As previously discussed, the role of the user defines what actions the user can command the safe 10 to perform. Each set of actions has a corresponding GUI. The controller module 312 determines which GUIs should be displayed so as to allow the user the ability to perform the actions corresponding to the role of the user. The controller module 312 can obtain this information from, for example, a lookup table or similar structure. Once the GUI or GUIs are determined, the controller module 312 transmits the instruction to the mobile computing device 20 indicating the one or more GUIs that are to be displayed. In some implementations, the controller module 312 may be further configured to provide one or more files containing the one or more GUIs.

At operation 352, the controller module 312 determines whether a command has been received from the mobile computing device 20. In implementations that utilize a virtual safe controller 60, the virtual safe controller 60 can wait for a command from the mobile computing device 20. If a command is received, the virtual safe controller 60 generates a packet containing the command and transmits the command to the mobile computing device 20, as shown at operation 354. The structure of the packet can be defined in the safe controller object used to instantiate the virtual safe controller 60.

At operation 356, the controller module 312 determines whether the control session has ended. If it has, the controller module 312 can deallocate the virtual safe controller 60, thereby ending the control session at the VSC server 30. Otherwise, the controller module 312 can continue to receive commands from the mobile computing device 20.

The method 330 is provided for example and not intended to be limiting. Variations of the method 330 are contemplated and are within the scope of the disclosure.

Referring back to FIG. 7, some user roles permit a user to request a report of one or more safes 10 associated with a customer. In some implementations, the processing device 300 executes a reporting module 314. The reporting module 314 receives a request for a report for a particular safe 10 or set of safes 10 from a computing device and responds with the report. The reporting module 314 may obtain the status of the implicated safe 10 or safes 10 from the safe database 322 and can generate the report based thereon. The report can include the deposits that have been made into the safe 10 or safes 10, the times of the deposits, withdrawals and/or pickups that have been made at the safe 10 or safes 10, the times of the withdrawals and/or pickups, and a total amount of funds in the safe 10. In some implementations, the reporting module 314 is further configured to report the status of each safe 10 to a bank or an affiliated party, such that a bank account of the customer may be credited with the money in each safe 10 prior to a pickup.

In some implementations, the controller module 312 is further configured to command one or more of the networked devices to instantiate a “redundancy controller” on one or more of the network devices, e.g., networked printer 104. A redundancy controller may be a proxy controller that allows a user to perform a limited amount of actions on the safe 10. For instance, the redundancy controller may be configured to only allow the user to operate the bill acceptor 102. When the controller module 312 determines that the network connection between the VSC sever 30 and the networked devices and/or the mobile computing device 20 is not reliable, the controller module 312 may command the redundancy controller to begin execution.

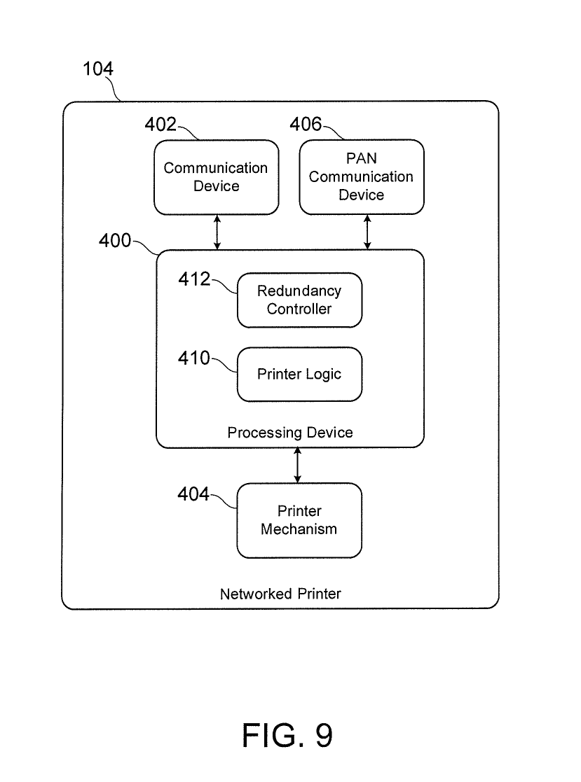

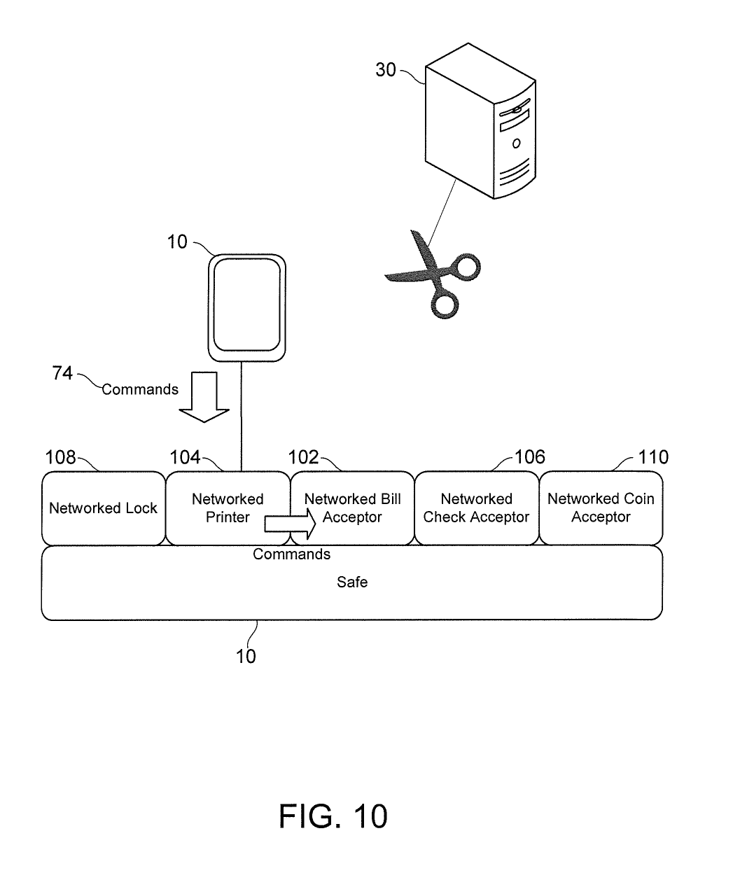

FIGS. 9 and 10 illustrate an example implementation of a safe 10 having a redundancy controller 412. In the illustrated example, the networked devices, e.g., the networked bill acceptor 102, the networked printer 104, the networked check acceptor 106, the networked lock 108, and the networked coin acceptor 110, are connected over a local area network (LAN). In the implementation depicted in FIG. 9, a redundancy controller 412 is instantiated by a processing device 400 of the networked printer 104. Thus, the processing device 410 of the networked printer 104 acts as an interface between the mobile computing device 20 and one or more of the other networked devices, in addition to executing the printer logic 410. As can be appreciated, the printer logic 410 controls the operation of the printer mechanism 404 in any suitable manner.

When the redundancy controller 412 is instantiated, it can act in a monitoring mode. In the monitoring mode, the redundancy controller 412 periodically or continuously checks the reliability of the network connection to the VSC server 30. When the redundancy controller 412 determines that the connection to VSC server 30 is lost, the redundancy controller 412 can enter an active mode. In the active mode, the redundancy controller 412 can locate the mobile computing device 20 either on the LAN or in its personal area network (PAN) and can instruct the mobile computing device 20 to display one or more GUIs corresponding to the functions which the redundancy controller 412 is configured to perform and the user has permission to perform, i.e., the intersection of the redundancy controller's 412 functionality and the user's role. The mobile computing device 20 can display the GUIs and can commence control of the safe 10.

The redundancy controller 412 may receive commands directly from the mobile computing device 20 and may command one or more of the networked devices. The redundancy controller 412 can receive commands from the mobile computing device 20 via the communication device 402 by way of the LAN or a PAN communication device 406, e.g., a Bluetooth transceiver or a near-field communication (NFC) transceiver. The redundancy controller 412 can generate commands 74 to an implicated network device based on the command 74 received from the mobile computing device 20. For example, the redundancy controller 412 may receive a command 74 to activate the networked bill acceptor 102 from the mobile computing device 20 via the PAN communication device 406. The redundancy controller 412 may format the command 74 in accordance with the schema or format that is accepted by the networked bill acceptor 102 and may forward the command 74 to the networked bill acceptor 102.

The redundancy controller 412 may maintain a log of the actions it performed, such that when the network connection between the networked devices and the VSC server 30 is restored, the redundancy controller 412 can report its actions to the VSC server 30.

It is noted that while the redundancy controller 412 is shown as being implemented on the networked printer 104, the redundancy controller may be implemented on any of the networked devices. Furthermore, in some implementations, the redundancy controller 412 may offer all of the features of a virtual safe controller 60.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
initiating, at a processing device of a server, a control session of a safe, the control session providing a user of a computing device control of one or more networked devices associated with the safe;
determining, at the processing device, a role of the user, the role being indicative of one or more actions that the user has permission to perform on a set of networked devices of the one or more networked devices;
transmitting, at the processing device, an instruction to the computing device indicating one or more graphical user interfaces to display at the computing device based on the role of the user;
receiving, at the processing device, a command from the computing device over a network indicating a commanded action to be performed on a networked device of the one or more networked devices; and
transmitting, at the processing device, the command to the networked device over the network.

2. The method of claim 1, further comprising,
receiving, at the processing device, authentication information of the user from the computing device; and
determining, at the processing device, the role of the user based on the authentication information.

3. The method of claim 1, further comprising:
determining, at the processing device, the set of networked devices based on the role of the user; and
determining, at the processing device, the one or more graphical user interfaces based on the set of networked devices and the one or more actions.

4. The method of claim 1, wherein initiating a control session includes instantiating, at the processing device, a virtual safe controller corresponding to the safe, the instantiated safe controller providing one or more interfaces to communicate with the set of networked devices.

5. The method of claim 4, wherein the instantiated virtual safe controller generates a packet indicating the command and transmits the packet to one of the networked device, the packet being configured for the networked device.

6. The method of claim 1, further comprising selecting, at the processing device, the safe from a plurality of safes.

7. The method of claim 6, wherein selecting the safe includes receiving a safe selection indicating the safe from the computing device.

8. The method of claim 6, wherein selecting the safe includes:
receiving, at the processing device, a location of the computing device,
selecting, at the processing device, the safe based on its proximity to the computing device.

9. The method of claim 8, wherein the safe is the most proximate of the plurality of safes to the computing device.

10. The method of claim 8, wherein the computing device is a mobile computing device.

11. A server comprising:
a communication device configured to communicate over a network;
a processing device that executes a controller module, the controller module being configured to:
initiate a control session of a safe, the control session providing a user of a computing device control of one or more networked devices associated with the safe;
determine a role of the user, the role being indicative of one or more actions that the user has permission to perform on a set of networked devices of the one or more networked devices;
transmit an instruction to the computing device indicating one or more graphical user interfaces to display at the computing device based on the role of the user;
receive a command from the computing device via the network, the command indicating a commanded action to be performed on a networked device of the one or more networked devices; and
transmit the command to the networked device over the network.

12. The server of claim 11, wherein the processing device executes an authentication module, the authentication module being configured to:
receive authentication information of the user from the computing device; and
determine the role of the user based on the authentication information.

13. The server of claim 11, wherein the controller module is further configured to:
determine the set of networked devices based on the role of the user; and
determine the one or more graphical user interfaces based on the set of networked devices and the one or more actions.

14. The server of claim 11, wherein the controller module initiates a control session by instantiating a virtual safe controller corresponding to the safe, the instantiated safe controller providing one or more interfaces to communicate with the set of networked devices over the network.

15. The server of claim 14, wherein the instantiated virtual safe controller generates a packet indicating the command and transmits the packet to one of the networked device, the packet being configured for the networked device.

16. The server of claim 11, wherein the controller module selects the safe from a plurality of safes.

17. The server of claim 16, wherein the controller module selects the safe by receiving a safe selection indicating the safe from the computing device.

18. The server of claim 16, wherein the controller module selects the safe by:
receiving a location of the computing device; and
selecting the safe based on its proximity to the computing device.

19. The server of claim 18, wherein the safe is the most proximate of the plurality of safes to the computing device.

20. The server of claim 18, wherein the computing device is a mobile computing device.

21. A system comprising:
a safe having one or more networked devices associated therewith, the networked devices each being connected to a network and performing a function related to the safe, the safe being without a user interface;
a mobile computing device having a user interface configured to receive input from and display output;
a virtual safe controller server configured to:
initiate a control session of the safe, the control session providing a user of the mobile computing device control of the one or more networked devices associated with the safe;
determine a role of the user, the role being indicative of one or more actions that the user has permission to perform on a set of networked devices of the one or more networked devices;
transmit an instruction to the mobile computing device indicating one or more graphical user interfaces to display at the mobile computing device based on the role of the user;
receive a command from the mobile computing device via the network, the command indicating a commanded action to be performed on a networked device of the one or more networked devices; and
transmit the command to the networked device over the network.

22. The system of claim 21, wherein the mobile computing device is configured to:
receive authentication information of the user via the user interface;
transmit the authentication information to the virtual safe controller;
receive the instruction in response to providing the authentication information;
displaying one of the one or more graphical user interfaces on the user interface;
receiving the command via the displayed graphical user interface; and
transmitting the command to the virtual safe controller.

23. The system of claim 22, wherein the virtual safe controller is further configured to receive the authentication information from the mobile computing device and determine the role of the user based on the authentication information.

24. The system of claim 21, wherein the safe is one of a plurality of safes that are controlled by the virtual safe controller server.

25. The system of claim 24, wherein:
the mobile computing device is configured to determine its location and provide its location to the virtual safe controller server; and
the virtual safe controller server is further configured to select the safe based on a proximity of the safe to the mobile computing device.

26. The system of claim 21, wherein the virtual safe controller is further configured to:
determine the set of networked devices based on the role of the user; and
determine the one or more graphical user interfaces based on the set of networked devices and the one or more actions.

27. The system of claim 11, wherein the virtual safe controller server is further configured to initiate a control session by instantiating a virtual safe controller corresponding to the safe, the instantiated safe controller providing one or more interfaces to communicate with the set of networked devices over the network.

28. The system of claim 27, wherein the instantiated virtual safe controller generates a packet indicating the command and transmits the packet to one of the networked device, the packet being configured for the networked device.

29. The system of claim 27, wherein the virtual safe controller server is further configured to command one of the networked devices to instantiate a redundancy controller, the redundancy controller being configured to control at least one other networked device based on commands received from the mobile computing device.

30. The method of claim 29, wherein the redundancy controller is configured to monitor a network connection with the virtual safe controller server and when the network connection is lost to initiate control of the at least one other networked device.
